(19) United States
(12) Patent Application Publication
(10) Pub. No.: US 2007/0280635 A1
(43) Pub. Date: Dec. 6, 2007

(54) METHOD AND APPARATUS CAPABLE OF ADJUSTING RECORDING TIME DYNAMICALLY

(76) Inventors: Chen-Hsiu HUANG, Chi-Lung (TW); Pin-Jen Chen, Taipei City (TW); Chun-Chia Su, Taipei City (TW); Ho-Chao HUANG, Taipei (TW); Ming-Jun CHEN, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/470,625

(22) Filed: Sep. 7, 2006

(30) Foreign Application Priority Data
Jun. 5, 2006 (TW) 095119862

(51) Int. Cl. H04N 5/91

(52) U.S. Cl. 386/83

(57) ABSTRACT

A method dynamically adjusts recording time based on the difference of the video/audio characteristics between two consecutive image clips in a designated program. First, the method receives data signals corresponding to a designated program including a plurality of consecutive image clips and commercial clips, each of which is broadcast between two corresponding images clips. The method begins to record the data signals at a predetermined start time. Next, the method compares the video/audio characteristic of a first image clip broadcast before a reference commercial clip and a second image clip broadcast directly after the reference commercial clip. If the difference of the video/audio characteristics between the first and second image clips is larger than a predetermined value, the method stops recording the data signals.

### BACKGROUND OF THE INVENTION

1. Field of the Invention

The present invention relates to a method and apparatus for recording programs, and more particularly, to a method and apparatus capable of adjusting recording time dynamically.

2. Description of the Prior Art

With the widespread use of television sets, related peripheral devices, such as recording devices, have also become common household equipment. Functions provided by household television platforms include pre-setting of power on/off, scheduled-recording of designated programs, or screen-dividing for viewing multiple programs simultaneously. Among these various functions, the most commonly used is the scheduled-recording function. By recording a user's favorite program or a program broadcast at an inconvenient time to the user, the user can view the recorded program over and over again or at a later time. In order to record a designated television program successfully, the recording device must be provided with information regarding the designated program, such as the channel on which the television program is to be broadcast, the scheduled broadcast start time of the television program, and the duration of the television program.

Television broadcast schedules can provide complete information of programs televised on each channel. As digital technologies progress, television broadcast schedules can include traditional printed paper television broadcast schedules, as well as digital television broadcast schedules including Electronic Program Guide (EPG) or Teletext. Regardless of the formats, traditional paper television broadcast schedules are widely available on various media, and digital television broadcast schedules can be downloaded via Internet. As a result, it is a relatively straightforward matter to program a recording device to record a desired television program according to a television broadcast schedule. However, certain types of televised programs, such as sporting events, live concerts or awards ceremonies, may extend beyond the time allotted in the television schedule. Take sporting events for example. In non-clocked games (the innings of baseball games or the sets of tennis matches), the actual program length depends mainly on match contents and may vary greatly. In clocked games (basketball, soccer or ice-hockey games), the program length is more predictable, but may still be influenced by various occurrences during the games, such as timeouts, fouls, or player injuries. If a user programs a recording device to record a live sport event according to a television broadcast schedule, the actual program length of the sport event is likely to exceed its scheduled broadcast length, and the final part of the sport event may fail to be recorded. This can cause considerable annoyance when the televised program extends beyond the scheduled broadcast end.

U.S. Pat. No. 6,252,629 “Timer-recording controller for controlling a timer-recording apparatus used to record a broadcast audio signal, a broadcast video signal, or a broadcast data signal” discloses a timer-recording controller. In this prior art, before the user creates a scheduled-recording program list according to a television broadcast schedule, the genres of televised programs that tend to extend beyond the scheduled broadcast end need to be identified as disruptor candidate programs by the user. Then, the prior art timer-recording controller detects each designated program in the scheduled-recording program list for the presence of disruptor candidate programs. If the scheduled-recording program list does not include any disruptor candidate program, the start and end recording time for each designated program are respectively set according to the scheduled-recording program list. If disruptor candidate programs are detected in the scheduled-recording program list, all detected disruptor candidate programs and subsequent designated programs that are likely to be influenced are displayed. The user can then determine whether the recording time of a designated program needs to be extended. In this prior art, the user needs to identify disruptor candidate programs and manually adjust the recording time for each designated program that is likely to be influenced by a disruptor candidate program. This can cause inconvenience for the user.

US Patent Application No. 2004/0202453 “METHOD AND APPARATUS FOR INSURING COMPLETE RECORDING OF A TELEVISION PROGRAM” discloses a method for recording a complete program. When the duration of a recording approximates its scheduled end time, this prior art detects groups or “clusters” of commercial messages. When such group is found near the end of a scheduled broadcast, it is presumed that the broadcast ends as scheduled and the recording is therefore terminated at the scheduled end time. If no such group is found near the end of the scheduled broadcast, it is presumed that the broadcast has been extended and the recording is likewise extended. The recording is terminated when commercial messages are detected or the maximum recording time has been reached. Since the formats of commercial messages aired in different regions vary, this prior art method has to provide corresponding detecting methods and can thus be very complicated. Also, the commercial messages may also appear in the scheduled broadcast period as well as in the extended period. The presence of commercial messages cannot accurately reflect whether a televised program extends beyond the scheduled broadcast end.

### SUMMARY OF THE INVENTION

The present invention provides a method capable of adjusting recording time dynamically comprising (a) receiving data signals corresponding to a program including a plurality of image clips and a plurality of commercial clips, wherein each of the commercial clips is broadcast between two consecutive images clips, (b) beginning to record the data signals at a scheduled start time, (c) comparing video and audio characteristics of a first image clip broadcast prior to a reference commercial clip with video and audio characteristics of a second image clip broadcast directly after the reference commercial clip, and (d) terminating recording the data signals if a difference of the video and audio characteristics between the first and second image clips is larger than a predetermined value.

The present invention also provides a method capable of adjusting recording time dynamically comprising (a) receiving data signals corresponding to a program including a plurality of image clips and a plurality of commercial clips, wherein each of the commercial clips is broadcast between two consecutive images clips, (b) beginning to record the data signals at a scheduled start time, (c) comparing overall video and audio characteristics of image clips broadcast prior to a reference commercial clip with reference video and audio characteristics of an reference image clip broadcast directly after the reference commercial clip, and (d) terminating recording the data signals if a difference between the overall video and audio characteristics the reference video and audio characteristics is larger than a predetermined value.

The present invention also provides an electronic device capable of adjusting recording time dynamically comprising a receiving means for receiving data signals corresponding to a program including a plurality of image clips and a plurality of commercial clips, wherein each of the commercial clips is broadcast between two consecutive images clips; a storing means for storing the data signals; a judging means for comparing first video and audio characteristics related to a first image clip broadcast prior to a reference commercial clip with second video and audio characteristics related to a second image clip broadcast directly after the reference commercial clip; and a control means for controlling the storing means based on a difference between the first and second image video and audio characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the structure of two consecutively televised programs.

FIG. 2 is a flowchart illustrating a method of dynamically adjusting recording time according to a first embodiment of the present invention.

FIG. 3 is a flowchart illustrating a method of dynamically adjusting recording time according to a second embodiment of the present invention.

FIG. 4 is a flowchart illustrating a method of dynamically adjusting recording time according to a third embodiment of the present invention.

FIG. 5 is a flowchart illustrating a method of dynamically adjusting recording time according to a fourth embodiment of the present invention.

FIG. 6 is a flowchart illustrating a method of dynamically adjusting recording time according to a fifth embodiment of the present invention.

FIG. 7 is a diagram listing the video/audio characteristics of major sport events.

### DETAILED DESCRIPTION

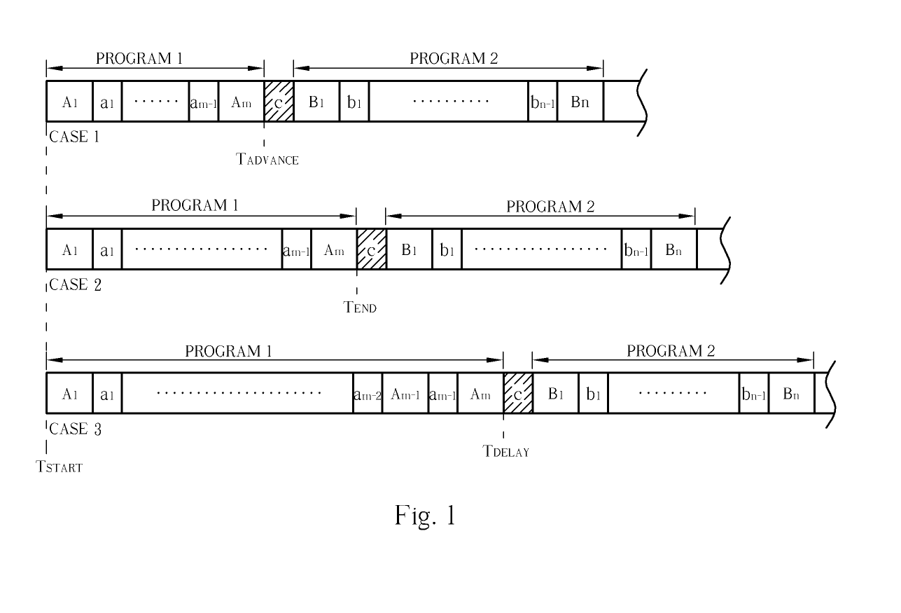

A television program can be defined as a conglomeration of a plurality image clips and a plurality of commercial clips, each of which is broadcast between two consecutive image clips. Reference is made to FIG. 1 for a diagram illustrating the structure of two consecutively televised programs. In FIG. 1, the horizontal axis represents time, and the two consecutively televised programs are respectively represented by PROGRAM1 and PROGRAM2. PROGRAM1 includes a plurality image clips A₁-Aₘ and a plurality of commercial clips a₁-aₘ₋₁ and PROGRAM2 includes a plurality image clips B₁-Bₙ and a plurality of commercial clips b₁-bₙ₋₁, while a commercial clip c is broadcast between PROGRAM1 and PROGRAM2. If PROGRAM1 is the designated program for scheduled-recording and its actual broadcast length often varies, the scheduled start time of PROGRAM1 is represented by T_{START} and the scheduled end time of PROGRAM1 is represented by T_{END}. Since the actual broadcast length of PROGRAM1 can differ, if the broadcast of PROGRAM1 finishes earlier than scheduled, its actual end time is represented by T_{ADVANCE}; if the broadcast of PROGRAM1 finishes later than scheduled, its actual end time is represented by T_{DELAY}; if the broadcast of PROGRAM1 finishes as scheduled, its actual end time is also represented by T_{END}. CASE1-CASE3 in FIG. 1 respectively illustrate situations when PROGRAM1 finishes earlier than, according to and later than its scheduled end time, respectively.

When recording PROGRAM1 continuously without considering the scheduled end time T_{END}, an image clip prior to a detected commercial clip can belong to PROGRAM1 (herein the detected commercial clip can refer to commercial clips a₁-aₘ₋₁, and c) or to PROGRAM2 (herein the detected commercial clip can refer to commercial clips b₁-bₙ₋₁). During the process of recording PROGRAM1, when detecting a first commercial clip (such as commercial clip b₁) that follows an image clip of PROGRAM2, then a commercial clip (such as commercial clip c) prior to the first commercial clip marks the end of PROGRAM1. For instance, in CASE1 when the broadcast of PROGRAM1 finishes earlier than scheduled, all commercial clips detected prior to its actual end time T_{ADVANCE} belong to PROGRAM1, while all commercial clips detected between its actual end time T_{ADVANCE} and its scheduled end time T_{END} do not belong to PROGRAM1. Once commercial clip c is detected, it means that PROGRAM1 is already over and the recording can thus be terminated. In CASE3 when the broadcast of PROGRAM1 finishes later than scheduled, the commercial clips detected between its scheduled start time T_{START} and its scheduled end time T_{END} belong to PROGRAM1, and the commercial clips detected between its scheduled end time T_{END} and its actual end time T_{DELAY} also belong to PROGRAM1. Once commercial clip c is detected, it means that PROGRAM1 is already over and the recording can thus be terminated. Therefore, by determining whether two image clips broadcast prior to and after a commercial clip belong to the same program, it can accurately be determined whether the broadcast of the designated program has already finished.

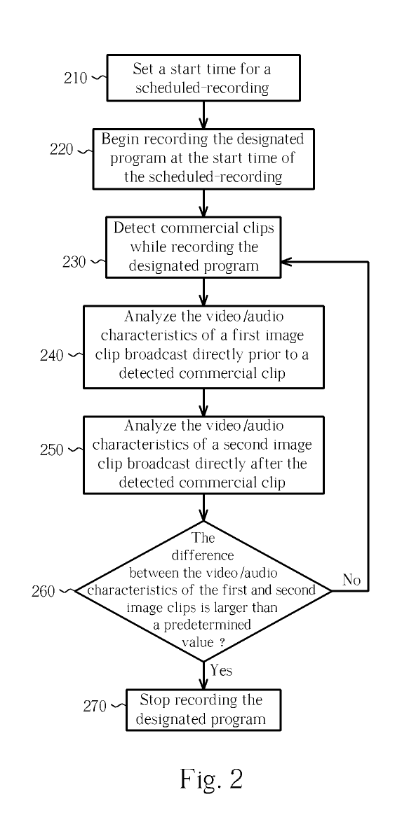

Different genres of programs possess different video/audio characteristics. The present invention detects commercial clips while recording a designated program and analyzes the video/audio characteristics of two image clips broadcast prior to and after each commercial clip. If the two image clips possess similar video/audio characteristics, the broadcast of the designated program is still ongoing and the recording continues; if the video/audio characteristics of the two image clips vary to a certain degree, the broadcast of the designated program has already finished and the recording is thus terminated. Reference is made to FIG. 2 for a flowchart illustrating a method of dynamically adjusting recording time according to a first embodiment of the present invention. FIG. 2 includes the following steps:

Step 210: set a start time for a scheduled-recording based on a scheduled broadcast start time and a scheduled broadcast end time of a designated program.

Step 220: begin recording the designated program at the start time of the scheduled-recording.

Step 230: detect commercial clips while recording the designated program.

Step 240: analyze the video/audio characteristics of a first image clip broadcast directly prior to a detected commercial clip.

Step 250: analyze the video/audio characteristics of a second image clip broadcast directly after the detected commercial clip.

Step 260: compare the difference between the video/audio characteristics of the first and second image clips; if the difference between the video/audio characteristics of the first and second image clips is larger than a predetermined value, execute step 270; if the difference between the video/audio characteristics of the first and second image clips is not larger than the predetermined value, execute step 230.

Step 270: stop recording the designated program.

In the first embodiment of the present invention, commercial clips are detected while recording the designated program in step 230. The first image clip broadcast directly prior to a detected commercial clip and the second image clip broadcast directly after the detected commercial clip are respectively analyzed in steps 240 and 250 for acquiring respective video/audio characteristics. Then step 260 compares the difference between the video/audio characteristics of the first and second image clips. If the difference between the video/audio characteristics of the first and second image clips is larger than the predetermined value, it means the broadcast of the designated program has already finished. In other words, the first image clip is the last image clip of the designated program and the second image clip is the first image clip of a subsequent program. Under these circumstances, the scheduled-recording is terminated in step 270. If the difference between the video/audio characteristics of the first and second image clips is not larger than the predetermined value, it means the broadcast of the designated program still continues. In other words, the first and second image clips both belong to the designated program. Under these circumstances, the first embodiment of the present invention executes step 230 again for detecting the next commercial clip.

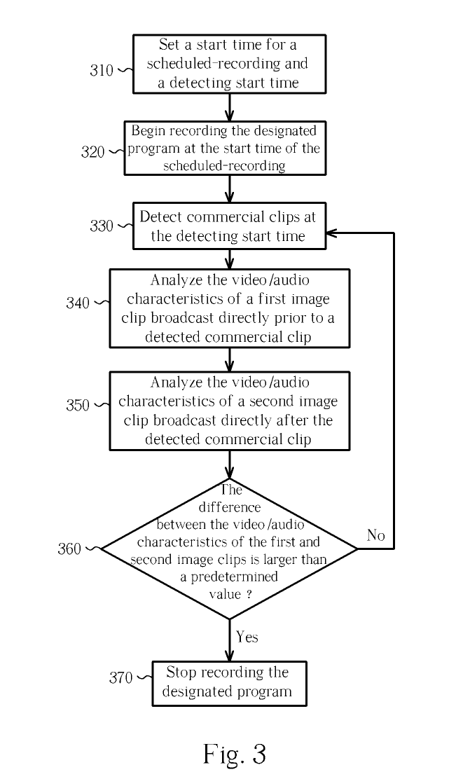

Reference is made to FIG. 3 for a flowchart illustrating a method of dynamically adjusting recording time according to a second embodiment of the present invention. FIG. 3 includes the following steps:

Step 310: set a start time for a scheduled-recording based on a scheduled broadcast start time and a scheduled broadcast end time of a designated program, and set a detecting start time between the scheduled broadcast start time and the scheduled broadcast end time of the designated program.

Step 320: begin recording the designated program at the start time of the scheduled-recording.

Step 330: detect commercial clips at the detecting start time.

Step 340: analyze the video/audio characteristics of a first image clip broadcast directly prior to a detected commercial clip.

Step 350: analyze the video/audio characteristics of a second image clip broadcast directly after the detected commercial clip.

Step 360: compare the difference between the video/audio characteristics of the first and second image clips; if the difference between the video/audio characteristics of the first and second image clips is larger than a predetermined value, execute step 370; if the difference between the video/audio characteristics of the first and second image clips is not larger than the predetermined value, execute step 330.

Step 370: stop recording the designated program.

The second embodiment differs from the first embodiment in that the first embodiment of the present invention begins to record the designated program and detect commercial clips simultaneously while in the second embodiment of the present invention, a detecting start time between the scheduled broadcast start time and the scheduled broadcast end time of the designated program is also set in step 310, and the detection of commercial clips begins at the detecting start time in step 330. Although the actual broadcast length of the designated programs may vary, it usually does not deviate too much from its scheduled broadcast end time. In the second embodiment of the present invention, the detecting start time can be set at a time slightly earlier than the scheduled broadcast end time. At the detecting start time, the second invention of the present invention starts to detect commercial slips and determines whether the broadcast of the designated program is over based on the difference between the video/audio characteristics of corresponding first and second image clips.

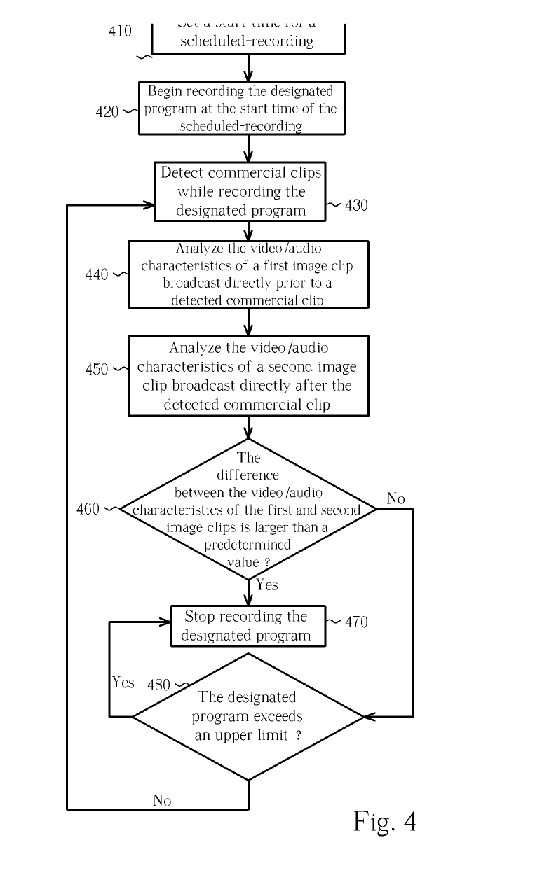

Reference is made to FIG. 4 for a flowchart illustrating a method of dynamically adjusting recording time according to a third embodiment of the present invention. FIG. 4 includes the following steps:

Step 410: set a start time for a scheduled-recording based on a scheduled broadcast start time and a scheduled broadcast end time of a designated program.

Step 420: begin recording the designated program at the start time of the scheduled-recording.

Step 430: detect commercial clips while recording the designated program.

Step 440: analyze the video/audio characteristics of a first image clip broadcast directly prior to a detected commercial clip.

Step 450: analyze the video/audio characteristics of a second image clip broadcast directly after the detected commercial clip.

Step 460: compare the difference between the video/audio characteristics of the first and second image clips; if the difference between the video/audio characteristics of the first and second image clips is larger than a predetermined value, execute step 470; if the difference between the video/audio characteristics of the first and second image clips is not larger than the predetermined value, execute step 480.

Step 470: stop recording the designated program.

Step 480: determine whether the recording time of the designated program exceeds an upper limit; if the designated program exceeds the upper limit, execute step 470; if the designated program does not exceed the upper limit, execute step 430.

The third embodiment differs from the first embodiment in that in the first embodiment of the present invention, step 270 is executed for ending the scheduled-recording only when the difference between the video/audio characteristics of the first and second image clips is determined to be larger than the predetermined value in step 260 while in the third embodiment of the present invention, when the difference between the video/audio characteristics of the first and second image clips is not larger than the predetermined value, step 480 is executed for determining whether the recording time of the designated program exceeds the upper limit. If the recording time of the designated program already exceeds the upper limit, step 470 is executed and the scheduled-recording is directly ended. In the third embodiment of the present invention, the upper limit can be set according to the memory capacity of a recording device.

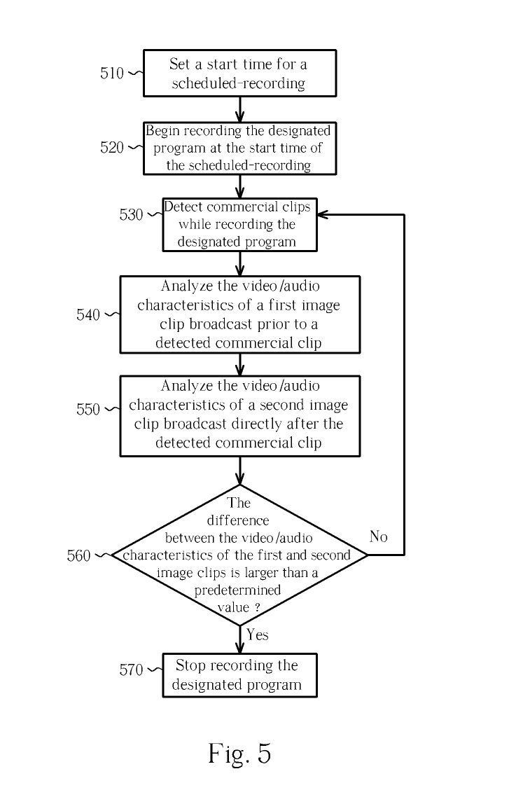

Reference is made to FIG. 5 for a flowchart illustrating a method of dynamically adjusting recording time according to a fourth embodiment of the present invention. FIG. 5 includes the following steps:

Step 510: set a start time for a scheduled-recording based on a scheduled broadcast start time and a scheduled broadcast end time of a designated program.

Step 520: begin recording the designated program at the start time of the scheduled-recording.

Step 530: detect commercial clips while recording the designated program.

Step 540: analyze the video/audio characteristics of a first image clip broadcast prior to a detected commercial clip.

Step 550: analyze the video/audio characteristics of a second image clip broadcast directly after the detected commercial clip.

Step 560: compare the difference between the video/audio characteristics of the first and second image clips; if the difference between the video/audio characteristics of the first and second image clips is larger than a predetermined value, execute step 570; if the difference between the video/audio characteristics of the first and second image clips is not larger than the predetermined value, execute step 530.

Step 570: stop recording the designated program.

The fourth embodiment differs from the first through third embodiments in that in the first through third embodiments of the present invention, the first image clip is an image clip that is broadcast directly prior to the detected commercial clip while in the fourth embodiment of the present invention, the first image clip can be any image clip that is broadcast prior to the detected commercial clip. If the difference between the video/audio characteristics of the first and second image clips is larger than the predetermined value, it means the broadcast of the designated program has already finished and step 570 is executed for ending the scheduled-recording.

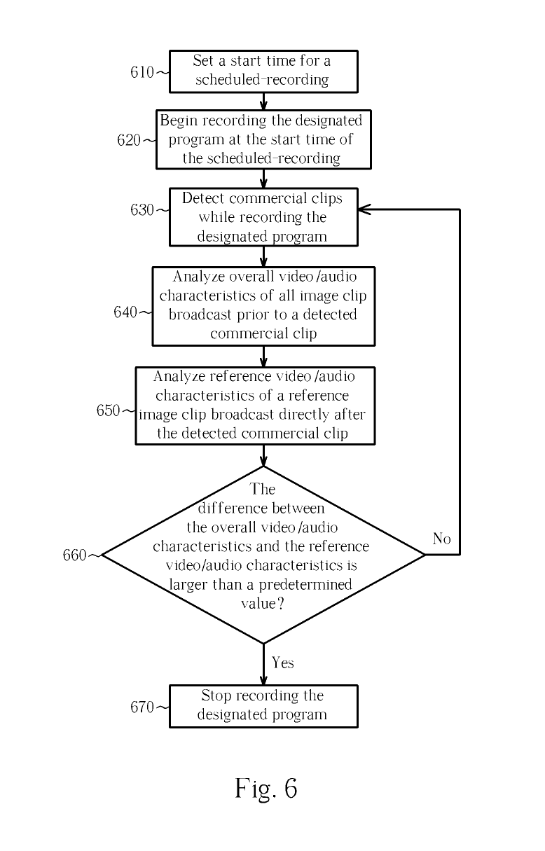

Reference is made to FIG. 6 for a flowchart illustrating a method of dynamically adjusting recording time according to a fifth embodiment of the present invention. FIG. 6 includes the following steps:

Step 610: set a start time for a scheduled-recording based on a scheduled broadcast start time and a scheduled broadcast end time of a designated program.

Step 620: begin recording the designated program at the start time of the scheduled-recording.

Step 630: detect commercial clips while recording the designated program.

Step 640: analyze overall video/audio characteristics of all image clip broadcast prior to a detected commercial clip.

Step 650: analyze reference video/audio characteristics of a reference image clip broadcast directly after the detected commercial clip.

Step 660: compare the difference between the overall video/audio characteristics and the reference video/audio characteristics; if the difference between the overall video/audio characteristics and the reference video/audio characteristics is larger than a predetermined value, execute step 670; if the difference between the difference between the overall video/audio characteristics and the reference video/audio characteristics is not larger than the predetermined value, execute step 630.

Step 670: stop recording the designated program.

The fifth embodiment differs from the first embodiment in that in the first embodiment of the present invention, the video/audio characteristics of the first and second image clips, which are respectively broadcast directly prior to and directly after the detected commercial clip, are analyzed for determining when to end the scheduled-recording while in the fifth embodiment of the present invention, all image clips broadcast prior to the detected commercial clip are analyzed for acquiring the overall video/audio characteristics, while the reference image clip broadcast directly after the detected commercial clip is analyzed for acquiring the reference video/audio characteristics. If the difference between the overall video/audio characteristics and the reference video/audio characteristics is larger than the predetermined value, it means the broadcast of the designated program has already finished and step 670 is executed for ending the scheduled-recording.

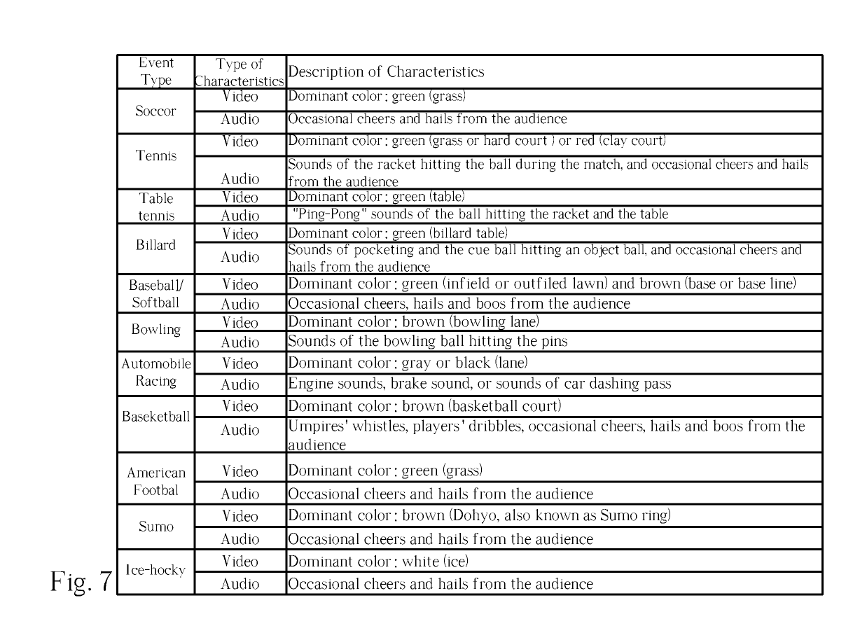

For example, sport events feature distinctive video/audio characteristics. Reference is made to FIG. 7 for a diagram listing the video/audio characteristics of major sport events. The video characteristics listed in FIG. 7 refer to the dominant color visible during the broadcast of the sport event and are mainly related to the color of the arena where the sport event is held. The audio characteristics listed in FIG. 7 refer to the background sounds during the sport event, and can be made by the players or the audiences. The first embodiment illustrated in FIGS. 1 and 2 is used as an example. Assume that PROGRAM1 is a sport event and PROGRAM2 is not a sport event, and a user only wants to perform scheduled-recording on PROGRAM1. When the present invention detects a commercial clip in step 230 and the detected commercial clip belongs to one of the commercial clips a₁-aₘ₋₁, its corresponding first and second image clips both belong to PROGRAM1. Therefore, in steps 240 and 250, similar video/audio characteristics will be obtained after analyzing the first and second image clips. After the comparison in step 260, the scheduled-recording continues and step 230 is executed again for detecting the next commercial clip. When the present invention detects the commercial clip c, its corresponding first image clip Aₘ and the second image clip B₁ belong to PROGRAM1 and PROGRAM2, respectively. Therefore, in steps 240 and 250, different video/audio characteristics will be obtained after analyzing the first and second image clips. After the comparison in step 260, it can be determined that the difference between the video/audio characteristics of the image clip Aₘ and B₁ is larger than the predetermined value, which means the broadcast of PROGRAM1 has already finished. Thus, step 270 is executed for ending the scheduled-recording.

Though the actual end time of PROGRAM1 can be T_{ADVANCE}, T_{END}, or T_{DELAY}, the present invention can accurately determine the actual end time of PROGRAM1 by comparing the video/audio characteristics of the two image clips broadcast prior to and after a commercial clip. The present invention will not record unnecessary contents when the broadcast of PROGRAM1 ends earlier than scheduled, nor fail to record the final part of PROGRAM1 when the broadcast of PROGRAM1 ends later than scheduled.

The video/audio characteristics listed in FIG. 7 are merely embodiments of the present invention. The present invention can also control the length of a scheduled-recording by comparing other video/audio characteristics. For example, the video characteristics can include the dominant color of the arena, as well as a specific way that a sport event proceeds. Two common examples are the shot-switching between a pitcher, a catcher, a batter and umpires in a baseball game, and the unmistakable salt-tossing ritual before a Sumo match. Also, the scoreboard or other game log information are constantly shown on the screen while broadcasting many sport events. The present invention can also recognize changes in video/audio characteristics by detecting the presence of a scoreboard or a special format of game log (such as the diamond-shaped game log resembling the top-view of a baseball stadium in a baseball game). Similarly, the present invention can also control the length of a scheduled-recording by comparing other video/audio characteristics typical to other types of televised programs. For example, in a live rock-and-roll concert, the dazzling and changing visual effects can be used as the judging video characteristics, while stunning music, shouting, and screaming can be used as the judging audio characteristics. The video/audio characteristics of major sport events listed in FIG. 7 are merely embodiments of the present invention and do not limit the scope of the present invention.

In the steps 210, 310, 410, 510 and 610 of the present invention, the starting time of the scheduled-recording can be set based on traditional paper television broadcast schedules available on various media, or digital television broadcast schedules downloaded via Internet, such as Electronic Program Guide (EPG), Interactive Program Guide (IPG), Electronic Service Guide (ESG), or Teletext. Also, video/audio characteristics related to a designated program can be defined by the user, or can be acquired by analyzing the designated program when being recorded using a recording device on a real-time basis.

The present invention detects commercial clips while performing scheduled-recording on a designated program. The actual end time of the designated program can be determined by comparing the video/audio characteristics of the two image clips broadcast prior to and after a commercial clip. The present invention will not record unnecessary program material when the broadcast of designated program ends earlier than scheduled, nor fail to record the final part of the designated program when the broadcast of the designated program ends later than scheduled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method capable of adjusting recording time dynamically comprising the following steps:
(a) receiving data signals corresponding to a program including a plurality of image clips and a plurality of commercial clips, wherein each of the commercial clips is broadcast between two consecutive images clips;
(b) beginning to record the data signals at a scheduled start time;
(c) comparing video and audio characteristics of a first image clip broadcast prior to a reference commercial clip with video and audio characteristics of a second image clip broadcast directly after the reference commercial clip; and
(d) terminating recording the data signals if a difference of the video and audio characteristics between the first and second image clips is larger than a predetermined value.

2. The method of claim 1 further comprising setting the scheduled start time.

3. The method of claim 1 further comprising locating the reference commercial clip from the plurality of commercial clips.

4. The method of claim 1 further comprising analyzing the video and audio characteristics of the first and second image clips.

5. The method of claim 1 further comprising inputting video and audio characteristics corresponding to the program, and wherein step (c) comprises comparing the video and audio characteristics of the first image clip with those of the second image clip based on the inputted video and audio characteristics.

6. The method of claim 1 further comprising:
determining a genre of the program based on the data signals; and
generating reference video and audio characteristics based on the genre of the program.

7. The method of claim 6 wherein step (c) comprises:
calculating a first value corresponding to a difference between the reference video and audio characteristics and the video and audio characteristics of the first image clip;
calculating a second value corresponding to a difference between the reference video and audio characteristics and the video and audio characteristics of the second image clip; and
comparing the video and audio characteristics of the first image clip with the video and audio characteristics of the second image clip based on the first and second values.

8. The method of claim 1 further comprising determining whether a recording time of the data signals exceeds an upper limit.

9. The method of claim 8 further comprising terminating recording the data signals if the recording time of the data signals exceeds the upper limit.

10. The method of claim 1 further comprising receiving control signals corresponding to a scheduled broadcast length, a scheduled broadcast start time, a scheduled broadcast end time, and a scheduled broadcast channel of the program.

11. The method of claim 10 further comprising:
setting the scheduled start time and a scheduled end time based on the control signals.

12. The method of claim 11 further comprising:
locating the reference commercial clip which is closest to the scheduled end time and does not exceed the scheduled end time from the program.

13. The method of claim 10 further comprising:
setting a detecting start time between the scheduled start time and the scheduled end time of the program based on the control signals.

14. The method of claim 13 further comprising:
locating the reference commercial clip from the program at the detecting start time.

15. The method of claim 1 further comprising:
receiving an Electronic Program Guide (EPG), an Interactive Program Guide (IPG), an Electronic Service Guide (ESG), or a Teletext corresponding to a genre, a scheduled broadcast length, a scheduled broadcast start time, a scheduled broadcast end time, and a scheduled broadcast channel of the program.

16. The method of claim 1 wherein step (c) comprises comparing the video and audio characteristics of the first image clip broadcast directly prior to the reference commercial clip with the video and audio characteristics of the second image clip broadcast directly after the reference commercial clip.

17. A method capable of adjusting recording time dynamically comprising the following steps:
(a) receiving data signals corresponding to a program including a plurality of image clips and a plurality of commercial clips, wherein each of the commercial clips is broadcast between two consecutive images clips;
(b) beginning to record the data signals at a scheduled start time;
(c) comparing overall video and audio characteristics of image clips broadcast prior to a reference commercial clip with reference video and audio characteristics of an reference image clip broadcast directly after the reference commercial clip; and
(d) terminating recording the data signals if a difference between the overall video and audio characteristics and the reference video and audio characteristics is larger than a predetermined value.

18. The method of claim 17 wherein step (c) comprises comparing overall video and audio characteristics of all image clips broadcast prior to the reference commercial clip with the reference video and audio characteristics of the reference image clip broadcast directly after the reference commercial clip.

19. The method of claim 18 further comprising setting the scheduled start time.

20. The method of claim 18 further comprising locating the reference commercial clip from the plurality of commercial clips.

21. The method of claim 18 further comprising:
analyzing the image clips broadcast prior to the reference commercial clip for generating the overall video and audio characteristics; and
analyzing the reference image clip broadcast directly after the reference commercial clip for generating the reference video and audio characteristics.

22. The method of claim 18 further comprising determining whether a recording time of the data signals exceeds an upper limit.

23. The method of claim 22 further comprising terminating recording the data signals if the recording time of the data signals exceeds the upper limit.

24. The method of claim 17 further comprising receiving control signals corresponding to a scheduled broadcast length, a scheduled broadcast start time, a scheduled broadcast end time, and a scheduled broadcast channel of the program.

25. The method of claim 24 further comprising:
setting the scheduled start time and a scheduled end time based on the control signals.

26. The method of claim 25 further comprising:
locating the reference commercial clip which is closest to the scheduled end time and does not exceed the scheduled end time from the program.

27. The method of claim 24 further comprising:
setting a detecting start time between the scheduled start time and the scheduled end time of the program based on the control signals.

28. The method of claim 27 further comprising:
locating the reference commercial clip from the program at the detecting start time.

29. The method of claim 17 further comprising:
receiving an Electronic Program Guide, an Interactive Program Guide, an Electronic Service Guide, or a Teletext corresponding to a genre, a scheduled broadcast length, a scheduled broadcast start time, a scheduled broadcast end time, and a scheduled broadcast channel of the program.

30. An electronic device capable of adjusting recording time dynamically comprising:
a receiving means for receiving data signals corresponding to a program including a plurality of image clips and a plurality of commercial clips, wherein each of the commercial clips is broadcast between two consecutive images clips;
a storing means for storing the data signals;
a judging means for comparing first video and audio characteristics related to a first image clip broadcast prior to a reference commercial clip with second video and audio characteristics related to a second image clip broadcast directly after the reference commercial clip; and
a control means for controlling the storing means based on a difference between the first and second image video and audio characteristics.

31. The electronic device of claim 30 further comprising:
an analyzing means for analyzing the first and second image clips and thereby generating the first and second video and audio characteristics.

32. The electronic device of claim 30 wherein the judging means compares the first video and audio characteristics related to the first image clip and a third image clip broadcast prior to the reference commercial clip with the second video and audio characteristics related to the second image clip.

33. The electronic device of claim 32 further comprising:
an analyzing means for analyzing the first and third image clips and thereby generating the first video and audio characteristics, and for analyzing the second image clip and thereby generating the second video and audio characteristics.
